(19) United States
(12) Patent Application Publication
(10) Pub. No.: US 2008/0306969 A1
(43) Pub. Date: Dec. 11, 2008

(54) METHOD AND SYSTEM FOR IMPROVING APPLICATIONS BASED ON LOCATION INFORMATION OF OBJECTS

(76) Inventors: Chand Mehta, Santa Clara, CA (US); Jitendra Dhawas, Mountain House, CA (US)

Correspondence Address: JAY M. Schloff;Intellipex PLLC, Suite 245, 30200 Telegraph Road, Bingham Farms, MI, 48025, US

(21) Appl. No.: 12/181,534

(22) Filed: Jul. 29, 2008

Related U.S. Application Data
(63) Continuation-in-part of application No. 10/906,441, filed on Feb. 19, 2005, now abandoned.

(51) Int. Cl. G06F 17/30

(52) U.S. Cl. 707/10; 707/E17.032

(57) ABSTRACT

Disclosed is a system for improving applications based on location information of objects. The system includes a receiver module configured to receive the location information of the objects from at least one location database in a communication network. The objects are associated with corresponding location-aware devices. Each location-aware device of the location-aware devices includes the location information of at least one object of the objects. Further, a processing module included in the system is configured to generate at least one of behavioral and trending information of the objects and vehicular traffic information based on the location information of the objects. Furthermore, a transmitter module included in the system is configured to transmit at least one of the behavioral and trending information of the objects and the vehicular traffic information to at least one information database through the communication network. A method and a computer program product are also disclosed.

### CROSS-REFERENCE TO RELATED APPLICATIONS

This application is a continuation application of U.S. application Ser. No. 10/906,441, filed Feb. 19, 2005.

### BACKGROUND OF THE INVENTION

1. Field of the Invention

The present invention relates generally to locations of objects, and, more particularly, to improving applications based on location information of the objects.

2. Description of Related Art

Location information of an object may be defined as information that describes location of the object. The location information of the object may include various location parameters, such as latitude, longitude, altitude, velocity, direction, time, and the like. Examples of the object include, but are not limited to, humans and vehicles. The location information of objects may be utilized in various applications, such as vehicular traffic modeling, gathering behavioral and trending information of the objects, tracking an object, and the like.

Current methods and systems that exist for vehicular traffic modeling perform various processes, such as, gathering vehicular traffic data, estimating travel time and path from source to destination, actuating traffic control devices, detecting congestion, queues, crashes and breakdowns on roadways, and the like. The vehicular traffic data may also be used for highway planning and maintenance by public agencies, such as, a Department of Transportation, Federal Highway Administration, and the like.

Loop detectors have been used for several years for gathering vehicular traffic data, and are the backbone of traffic management and data collection systems today. Inductive Loop Detectors (ILDs) are commonly used on freeways and arterial roadways to collect real-time data on vehicle presence, vehicle speed and vehicle length. The ILDs require deployment of special purpose devices for gathering the vehicular traffic data. The gathered vehicular traffic data is transmitted to a central server for archiving and processing. Another method for gathering the vehicular traffic data involves microwave radars.

The microwave radars operate by emitting electromagnetic waves for measuring reflections to determine a vehicle's presence, location, speed and motion. The method involves deployment of the microwave radars on highways and roadways.

Yet another method for gathering the vehicular traffic information involves use of Global Positioning System (GPS) enabled vehicles. A GPS-enabled vehicle transmits the location information to a central server. The method may require deployment of GPS receivers in vehicles.

Current methods and systems for gathering the behavioral and trending information of the objects, such as humans, involve market surveys and census information.

The methods and systems utilized for the applications based on the location information suffer from a few drawbacks. The methods and systems described for the vehicular traffic modeling require deployment of expensive special purpose equipment for gathering the vehicular traffic data. The current methods and systems for gathering the behavioral and trending information of the objects do not utilize the location information of the objects. However, the location information is a convenient indicator of the behavioral and trending information of the objects.

Based on the foregoing, there is need for a method and system, based on the location information of the objects that improvise the applications, such as vehicular traffic modeling, behavior and trend modeling, tracking objects, and the like. Further, the method and system should facilitate low cost and convenient retrieval of the location information of the objects. Furthermore, the method and system should not require deployment of expensive special purpose equipment for gathering the location information of the objects.

### SUMMARY OF THE INVENTION

In view of the foregoing disadvantages inherent in the prior art, the general purpose of the present invention is to provision for improving applications based on location information of objects, that is configured to include all advantages of the prior art, and to overcome the drawbacks inherent therein.

Accordingly, an object of the present invention is to improve applications that are based on location information of objects.

Another object of the present invention is to provide a globally scalable system and method for improving applications that are based on location information of objects.

Still another object of the present invention is to obtain location information of objects in a convenient manner.

Yet another object of the present invention is to avoid deployment of special purpose equipment for obtaining location information of objects.

In an aspect of the present invention, a system is provided for improving applications based on location information of a plurality of objects. The system includes a receiver module, a processing module and a transmitter module. The receiver module is configured to receive the location information of the plurality of objects from at least one location database in a communication network. Each of the plurality of objects is associated with a corresponding location-aware device. The location-aware device includes the location information of at least one object of the plurality of objects. Further, the processing module is configured to generate at least one of object behavioral and trending information and vehicular traffic information based on the location information of the plurality of objects. Furthermore, the transmitter module is configured to transmit at least one of the object behavioral and trending information and the vehicular traffic information to at least one information database through the communication network.

In another aspect of the present invention, a method is provided for improving applications based on location information of a plurality of objects. The method includes receiving the location information of the plurality of objects from at least one location database in a communication network. Each of the plurality of objects is associated with a corresponding location-aware device. The location-aware device includes the location information of at least one object of the plurality of objects. Further, the method includes generating at least one of object behavioral and trending information and vehicular traffic information based on the location information of the plurality of objects. Furthermore, the method includes transmitting at least one of the object behavioral and trending information and the vehicular traffic information generated to at least one information database through the communication network.

In yet another aspect of the present invention, a computer program product embodied on a computer readable medium is provided for improving applications based on location information of a plurality of objects. The computer program product includes a program module. The program module includes a set of instructions for receiving the location information of the plurality of objects from at least one location database in a communication network. Each of the plurality of objects is associated with a corresponding location-aware device. The location-aware device includes the location information of at least one object of the plurality of objects. Further, the program module includes a set of instructions for generating at least one of object behavioral and trending information and vehicular traffic information based on the location information of the plurality of objects. Furthermore, the program module includes a set of instructions for transmitting at least one of the object behavioral and trending information and the vehicular traffic information generated to at least one information database through the communication network.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a schematic diagram of an environment in which various embodiments of the present invention may be practiced;

FIG. 2 depicts a schematic diagram of a system communicating with a location database for improving applications based on location information of a plurality of objects, in accordance with an exemplary embodiment of the present invention;

FIG. 3 is a flow diagram representing a method for improving the applications based on the location information of the plurality of objects, in accordance with an embodiment of the present invention; and

FIG. 4 is a flow diagram representing a method for improving the applications based on the location information of the plurality of objects, in accordance with another embodiment of the present invention.

### DETAILED DESCRIPTION OF THE INVENTION

For a thorough understanding of the present invention, reference is to be made to the following detailed description, including the appended claims, in connection with the above-described drawings. Although the present invention is described in connection with exemplary embodiments, the present invention is not intended to be limited to the specific forms set forth herein. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item.

The present invention provides a system for improving applications that are based on location information of a plurality of objects. The location information herein represents information that describes location of an object. Examples of the object include, but are not limited to, a human being, a vehicle, and the like. The location information of the plurality of objects may be obtained from corresponding location-aware devices associated with the plurality of objects. Each location-aware device associated with an object is capable of estimating a location of the object. Examples of the location-aware devices include, but are not limited to, communication devices, such as mobile phones, laptops, Personal Digital Assistants (PDAs); and sensors, such as temperature sensors, Radio Detection and Ranging (RADAR), humidity sensors, and the like. The location-aware devices do not require deployment of expensive, special purpose equipment for gathering the location information of the plurality of objects. Further, obtaining the location information of the plurality of objects from the location-aware devices is a globally scalable and low cost approach for obtaining the location information.

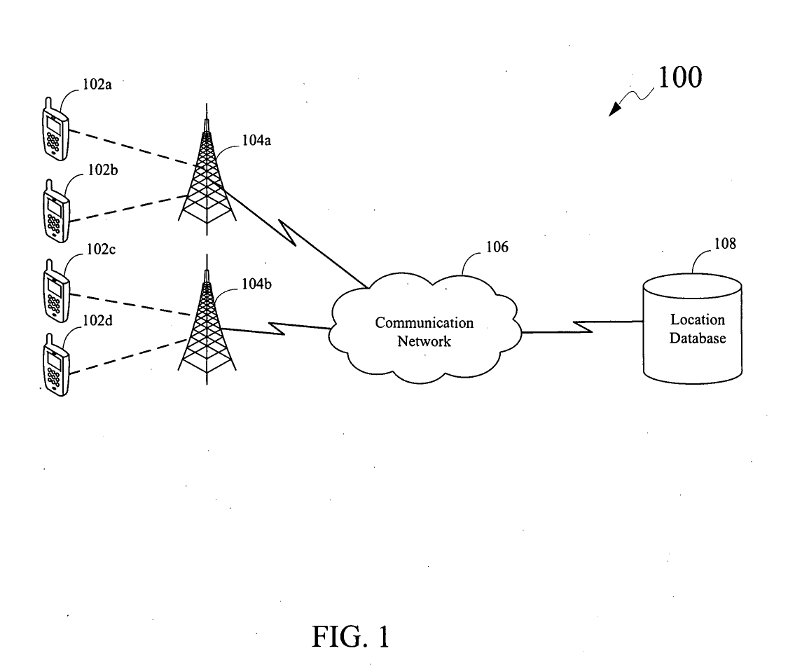

FIG. 1 depicts a schematic diagram of an environment 100 in which various embodiments of the present invention may be practiced. The environment 100 includes a location-aware device 102a, a location-aware device 102b, a location-aware device 102c, a location-aware device 102d, a base station 104a, a base station 104b, a communication network 106 and a location database 108. Further, the environment 100 also includes a plurality of objects (not shown).

For the purpose of description of the present invention, the location-aware devices 102a-1102d will hereinafter collectively be referred to as location-aware devices 102′. It will be apparent to a person skilled in the art that the environment 100 may also include sensors as the location-aware devices 102.

A location-aware device of the location-aware devices 102 is associated with at least one object of the plurality of objects. An object of the plurality of objects may be defined as an entity that is capable of movement and that may also host a location-aware device. Examples of the object include entities, such as, a human being, a vehicle, and other physical entities. Examples of the location-aware device include, but are not limited to, a communication device, such as a mobile phone, a laptop, a Personal Digital Assistant (PDA); and a sensor, such as a temperature sensor, Radio Detection and Ranging (RADAR) system, a humidity sensor, and the like. The location-aware device is capable of estimating location information of the at least one object, such as a RADAR sensor.

The location information of the object may be defined as information that describes location of the object. The location information of the object includes at least one of latitude of the object, longitude of the object, altitude of the object, velocity of the object, direction of the object and time. The time in the location information indicates an instant at which the location information was estimated by the location-aware devices 102. The time may also be defined as a time stamp that includes information of date and time. The location information may also include raw data, such as measurements of electromagnetic waves, and the like, that may be used to describe the location of the object. For example, the location information of an object may be represented as latitude 51° 28′ 38″, longitude 45° 12′ 25″, altitude 1000 meters above sea level and time stamp Tuesday, 1 Jul. 2008; 12:30 PM.

The location information of the at least one object estimated by the location-aware device is transmitted to a base station, such as the base station 104b through a transmission mechanism. The transmission mechanism may include a transmitter in the location-aware device, electromagnetic waves that include the location information and a receiver at the base station 104b.

The location information of the plurality of objects received at the base stations 104 is stored in at least one location database, such as the location database 108 through the communication network 106. The at least one location database may perform computations to transform the location information in a standardized format. For example, when the location information is in form of measurements of electromagnetic waves received by a RADAR sensor, the at least one location database may transform the location information into a standardized format. It will be apparent to a person skilled in the art that the transmission mechanism explained above may be specific to the location-aware devices 102 that are communication devices. However, other transmission mechanisms may be used to transmit the location information to the at least one location database when the location-aware devices 102 are sensors.

The location information is transmitted from the base stations 104 through the communication network 106 to the location database 108. Examples of the communication network 106 include Local Area Networks (LANs), Wide Area Networks (WANs), Metropolitan Area Networks (MANs), Wireless Fidelity (WiFi) networks, and the like. The location information of an object may be coupled with object identification information. The object identification information uniquely identifies at least one of an object of the plurality of objects and a location-aware device associated with the at least one object.

Without departing from the scope of the present invention, an example of the object identification information may include an alphanumeric Identifier (ID) that may be assigned to an object or to a location-aware device. The object identification information may get stored along with the location identification information of the plurality of objects in the at least one location database, such as the location database 108.

The location database 108 may be a Position Determination System (PDS). The PDS may vary based on technology employed by the location-aware devices 102. For example, a Serving Mobile Location Centre (SMLC) may be the PDS when the location-aware devices 102 employ Global System for Mobile communications (GSM) as a technology. GSM is defined in 3^{rd} Generation Partnership Project (3GPP) Technical Specification (TS) 44.031 dated January, 2005. In another example, a Position Determination Entity (PDE) or a Mobile Positioning Center (MPS) may be the PDS when the location-aware devices 102 employ Code Division Multiple Access (CDMA) network as a technology. The CDMA network is defined in Telecommunications Industries Association (TIA) Standards and Technology Department (STD) document number J-STD-036-1 dated January, 2001.

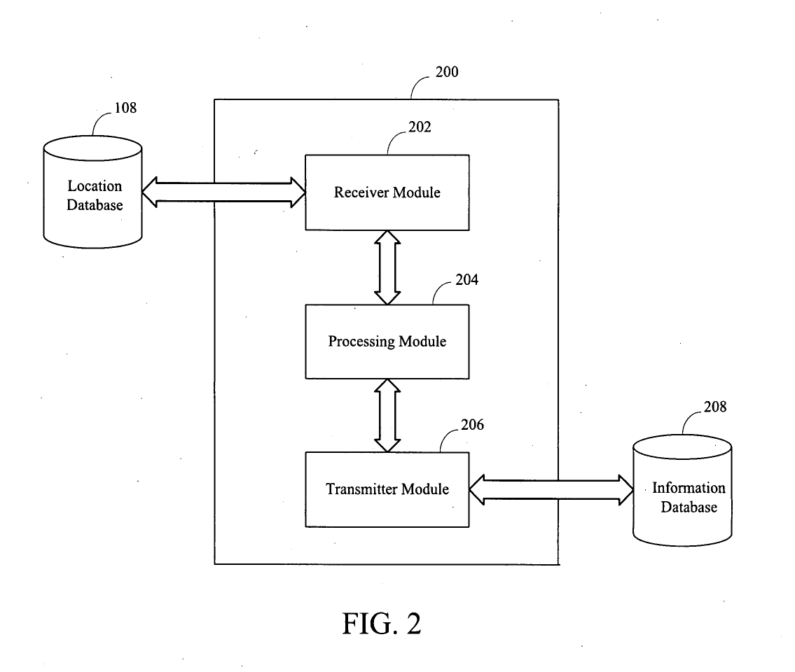

It will be apparent to a person that a combination of various PDSs may be utilized as the at least one location database for gathering the location information of the plurality of objects. Further, the at least one location database may include other information for estimating the location information, such as, Global Positioning system (GPS) reference information, base station related information, and the like. A system for improving applications that are based on utilizing location information of the plurality of objects is described in detail in FIG. 2.

FIG. 2 depicts a schematic diagram of a system 200 communicating with a location database, such as the location database 108, for improving the applications based on the location information of the plurality of objects, in accordance with an exemplary embodiment of the present invention. The system 200 includes a receiver module 202, a processing module 204 and a transmitter module 206. Further, FIG. 2 also includes an information database 208.

The receiver module 202 is configured to receive the location information of the plurality of objects from at least one location database, such as the location database 108 in a communication network (not shown), such as the communication network 106 of FIG. 1. Each of the plurality of objects is associated with a corresponding location-aware device. Each location-aware device of the location-aware devices includes the location information of at least one object of the plurality of objects.

Further, the processing module 204 is configured to generate at least one of object behavioral and trending information and vehicular traffic information based on the location information of the plurality of objects. Furthermore, the transmitter module 206 is configured to transmit at least one of the object behavioral and trending information and the vehicular traffic information generated by the processing module to at least one information database, such as the information database 208, through the communication network.

For the purpose of description of the present invention, the location information of an object of the plurality of objects may be defined as information that describes location of the object. As described in conjunction with FIG. 1, the location information of the object includes at least one of latitude of the object, longitude of the object, altitude of the object, velocity of the object, direction of the object and time. The time in the location information indicates an instant at which the location information was estimated by a location-aware device of the location-aware devices 102. The time may also be defined as a time stamp that includes information of date and time when the location information was estimated by the location-aware device. The location information may also include raw data, such as measurements of electromagnetic waves, and the like, that may be used to describe the location of the object.

As explained in conjunction with FIG. 1, the location information is stored in the at least one location database, such as the location database 108. The receiver module 202 is configured to receive the location information of the plurality of objects from the at least one location database. In an embodiment, the receiver module 202 is configured to receive the location information of the plurality of objects at periodic intervals from the at least one database.

In another embodiment, the receiver module 202 is configured to receive object identification information corresponding to the location information of the plurality of objects. The object identification information may be as defined in FIG. 1. The object identification information uniquely identifies at least one of an object of the plurality of objects and a location-aware device associated with the at least one object.

An object or a location-aware device may be identified by pseudo-object identification information in place of the object identification information, in order to preserve privacy of a person associated with the location-aware device. However, the object identification information that identifies at least one of the location-aware device and the object may be associated with the pseudo object identification information that is used for identification purposes.

In an embodiment, the object identification information and the location information may be received simultaneously by the receiver module 202.

The processing module 204 is configured to generate at least one of the object behavioral and trending information and the vehicular traffic information based on the location information of the plurality of objects. The object behavioral and trending information may be defined as information that indicates the behavior of an object of the plurality of objects and the trends followed by a set of objects of the plurality of objects.

Examples of the object behavioral and trending information for an individual object may include average time required to reach work from home, distance traveled from work to home, and the like. Examples of the object behavioral and trending information for a particular set of objects may include percentage of people traveling outside of a given region for work, percentage of people traveling to a given region for work, popular shopping mall in the region, and the like.

Similarly, the vehicular traffic information may be defined as information that indicates traffic conditions on different roadways in a particular area, based on the location information of vehicles. Examples of the vehicular traffic information include speed of the vehicles on a particular segment of a roadway, number of vehicles on the different roadways, average number of vehicles on a particular roadway at a particular time, and the like.

In an embodiment, the object identification information or the pseudo object identification information may be used by the processing module 204 to generate the vehicular traffic information and the object behavioral and trending information.

In another embodiment, the processing module 204 may be configured to generate at least one of an object behavior and trend model and a traffic flow model based on the object behavior and trending information and the vehicular traffic information, respectively. The object behavior and trend model may be utilized by marketing and sales units of various businesses, such as restaurants in a mall, outdoor advertisements on roadways, and the like, to improve product marketing strategies. For example, information regarding popular shopping mall in a particular region may be utilized for marketing and advertising, products and services by businesses, such as restaurants, beauty parlors, electronics, and the like.

In an embodiment, the object behavior and trending information may be used along with information from additional sources, such as market surveys and census information to devise marketing and advertising tools.

The traffic flow model generated by the processing module 204 is based on the vehicular traffic information that may be either real time or historical in nature. The traffic flow model may be used along with information from other sources, such as Inductive Loop Detectors (ILDs), microwave Radio Detection and Ranging (RADAR) systems and emergency response systems, such as Enhanced 911 (E911) system in the United States (US) and Public Safety Answering Point (PSAP) in the US, to provide a complete and accurate coverage of vehicular traffic in a particular region. The traffic flow model may also be used to actuate and control traffic lights and meters.

In an embodiment, the processing module 204 is configured to update at least one of the object behavioral and trending information and the vehicular traffic information based on the location information received at periodic intervals by the receiver module 202.

The transmitter module 206 is communicably coupled to the processing module 204. The transmitter module 206 is configured to transmit at least one of the object behavioral and trending information and the vehicular traffic information generated by the processing module 204 to the at least one information database, such as the information database 208, through the communication network 106. The at least one information database may be communicably coupled to external systems, such as Department of Transportation, and various businesses, for sharing information, such as the object behavioral and trending information, the vehicular traffic information, and the like.

In an embodiment, the transmitter module 206 is capable of transmitting at least one of the object behavior and trend model and the traffic flow model to the information database 208. As explained previously, the external systems may utilize the object behavior and trend model and the traffic flow model. It will be apparent to a person skilled in the art that the receiver module 202 and the transmitter module 206 may be configured together as a single entity, such as a transceiver module, capable of receiving the location information and transmitting information generated by the processing module 204.

In another embodiment, the location information of the plurality of objects may be utilized by an organization, such as government and other public safety organizations, to track a particular object. The object may be tracked with the pseudo object identification information, when the organization has access to the object identification information of the object. The processing device 204 may be configured to process the location information specific to the object that needs to be tracked by the organization.

The system 200, as described above, may be deployed on a remote server. In an embodiment, the system 200 may be deployed within a location-aware device of the location-aware devices 102, and may be capable of exhibiting functionality as described above. In another embodiment, the system 200 may include a filtering module configured to filter the location information of the plurality of objects. For example, the location information such as, a stationary object or an object walking on a street may be filtered by the filtering module.

In an embodiment, the location-aware device may be a sensor with the system 200 deployed on the sensor. The sensor may be capable of estimating the location information using GPS or the at least one location database. The sensor may be a RADAR sensor capable of sensing speeds of at least one object of the plurality of objects on a particular roadway. The sensor may append the location information, such as latitude, longitude and altitude, to the speeds sensed, to form combined information. The combined information may then be utilized by the system 200 deployed on the sensor. Alternatively, the sensor may transmit the combined information to a central system, such as the system 200 that may be deployed at a remote location. A processing module, such as the processing module 204, of the central system may generate at least one of the object behavior and trend model and the traffic flow model in real time. Further, a plurality of sensors with the system 200 deployed on the plurality of sensors may be represented visually on a digital map of the region.

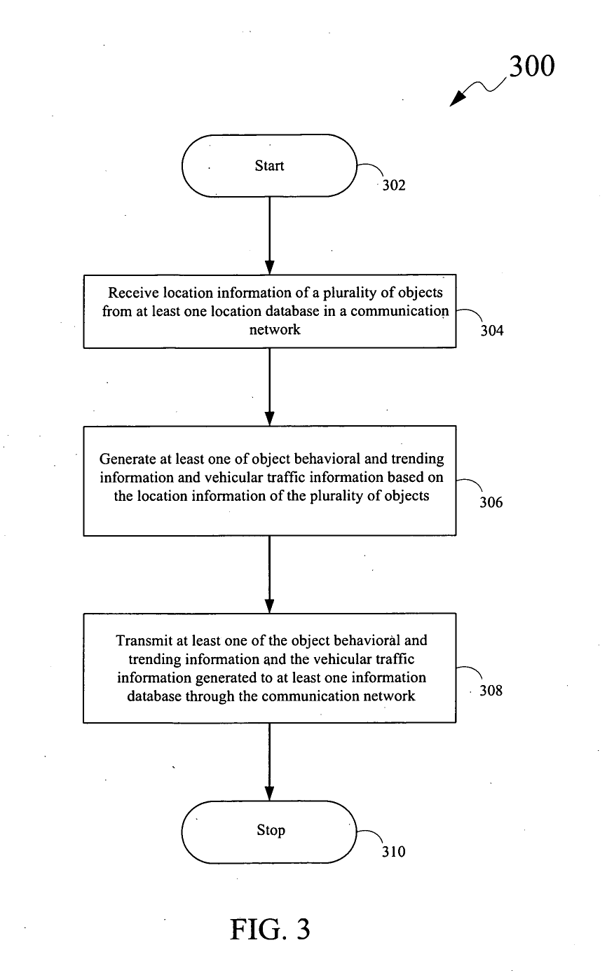

Further, it will be apparent to a person skilled in the art that more applications that are based on the location information of the plurality of objects may be improved by utilizing the system 200 described above. A method for improving applications that are based on the location information of the plurality of objects is explained in more detail in FIG. 3.

FIG. 3 is a flow diagram representing a method 300 for improving applications based on location information of a plurality of objects, in accordance with an embodiment of the present invention. For the purpose of description of FIG. 3, reference will be made to FIGS. 1 and 2 described previously.

The method 300 begins at 302. At 304, the location information of the plurality of objects is received from at least one location database in a communication network, such as the communication network 106. The plurality of objects is associated with corresponding location-aware devices. Each location-aware device of the location-aware devices includes the location information of at least one object of the plurality of objects. At 306, at least one of object behavioral and trending information and vehicular traffic information is generated based on the location information of the plurality of objects. At 308, at least one of the object behavioral and trending information and the vehicular traffic information that is generated is transmitted to at least one information database through the communication network. At 310, the method 300 ends.

For the purpose of description of the present invention, the location information of an object may be defined as information that describes location of the object. The location information of an object includes at least one of latitude of the object, longitude of the object, altitude of the object, velocity of the object, direction of the object and time. The time may be defined as an instant at which the location information of the object is estimated. Further, the time may include other information, such as day and date. The location information may also include raw data, such as measurements of electromagnetic waves, and the like, that may be used to describe the location of the object.

As explained previously, the location information of the plurality of objects is estimated by a location-aware device of the location-aware devices 102. An object of the plurality of objects may be defined as an entity that is capable of movement and that may also host a location-aware device. Examples of the object include entities, such as, humans, vehicles, and other physical entities. Examples of the location-aware device include, but are not limited to, a communication device, such as a mobile phone, a laptop and a Personal Digital Assistant (PDA); and a sensor, such as a temperature sensor, a Radio Detection and Ranging (RADAR) system, a humidity sensor, and the like. Each location-aware-device may be associated with at least one object of the plurality of objects. Further, each location-aware device may include the location information of the at least one object.

The location information of the plurality of objects is stored in the at least one location database, such as the location database 108, described in FIGS. 1 and 2. At 304, the location information is received from the at least one location database in the communication network.

At 306, at least one of the object behavioral and trending information and the vehicular traffic information is generated, based on the location information of the plurality of objects. As explained previously, the object behavioral and trending information may be defined as information that indicates the behavior of an object of the plurality of objects and the trends followed by a set of objects of the plurality of objects. Examples of the object behavioral and trending information may include average time required to reach work from home, percentage of people traveling outside of a given region for work, and the like.

The vehicular traffic information may be defined as information that indicates traffic conditions on different roadways in a particular area, based on the location information of vehicles. Examples of the vehicular traffic information include speed of the vehicles on a particular segment of a roadway, number of vehicles on the different roadways, and the like.

At 308, at least one of the vehicular traffic information and the object behavioral and trending information that is generated, is transmitted to the at least one information database, such as the information database 208. The at least one information database stores at least one of the vehicular traffic information and the object behavioral and trending information. The at least one information database may be communicably coupled to an external system, such as Department of Transportation, and various businesses, that may be based on the location information of the plurality of objects.

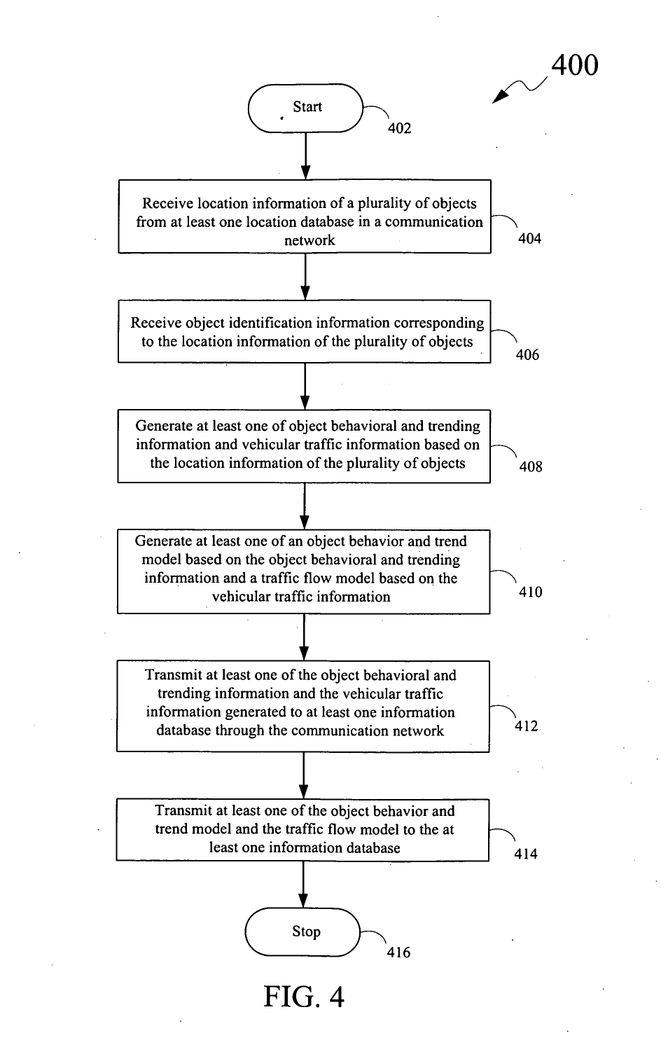

At 310, the method 300 ends. It will be apparent to a person skilled in the art that the method 300 may be used for other applications that are based on the location information of the plurality of objects. A method for improving the applications that are based on the location information of the plurality of objects is explained in FIG. 4 below.

FIG. 4 is a flow diagram representing a method 400 for improving the applications based on the location information of the plurality of objects, in accordance with another embodiment of the present invention.

At 402, the location information of the plurality of objects is available in at least one location database, such as the location database 108, explained in FIG. 1. The at least one location database may also store object identification information corresponding to the location information of the plurality of objects. As explained previously, the object identification information uniquely identifies at least one of an object of the plurality of objects and a location aware device associated with at least one object of the plurality of objects.

At 404, the location information of the plurality of objects is received from the at least one location database in a communication network, such as the communication network 106, explained in FIG. 1. For example, the location information of an object may be represented as latitude 23° 34′ 42″, longitude 13° 58′ 15″, altitude 200 meters above sea level, 30 km/hr and time stamp of Sunday, 6 Jul. 2008; 7:30 AM.

At 406, the object identification information of the plurality of objects is received from the at least one location database in the communication network. The object identification corresponds to the location information received previously. An example of the object identification information corresponding to the location information of the object may be an International Mobile Equipment Identity (IMEI) number that is unique for a particular mobile phone.

In an embodiment, pseudo object identification information may be associated with an object or a location-aware device, in order to preserve privacy of a person associated with the location-aware device. However, the object identification information of the location-aware device or the object may also be associated with the pseudo object identification information. In another embodiment, the location information, and one of the object identification information and the pseudo object identification information may be received simultaneously by a system, such as the system 200, explained in FIG. 2.

In an embodiment, the location information and the object identification information of the plurality of objects may be received at periodic intervals from the at least one location database. For example, a receiver module, such as the receiver module 202, explained in FIG. 2 may receive the location information and the object identification information of the plurality of objects after every twenty minutes during peak hours and after every one hour during other times of a day.

At 408, at least one of object behavioral and trending information and vehicular traffic information is generated, based on the location information of the plurality of objects. The object behavioral and trending information and the vehicular traffic information have been explained in conjunction with FIG. 3.

At 410, at least one of an object behavior and trend model and a traffic flow model is generated. The object behavior and trend model is generated based on the object behavioral and trending information. The traffic flow model is generated based on the vehicular traffic information. The object behavior and trend model may be utilized by marketing and sales departments of various businesses, such as outdoor advertisements on roadways, to improve product marketing strategies. For example, information regarding number of people traveling to a given region for work may be utilized for marketing and advertising, products and services on roadways and highways leading to the region by businesses, such as real estate developers, and the like.

In an embodiment, the object behavior and trending information may be used along with information from additional sources, such as market surveys and census information to devise marketing and advertising tools for products and services.

The traffic flow model may be used along with information from other sources, such as Inductive Loop Detectors (ILDs), microwave Radio Detection and Ranging (RADAR) systems and emergency response systems, such as the E911 system and the PSAP in the US, to provide a complete and accurate coverage of vehicular traffic in a particular region. The traffic flow model may also be used to actuate and control traffic lights.

In an embodiment, at least one of the object behavioral and trending information and the vehicular traffic information is updated, based on the location information received at periodic intervals. For example, during peak hours, the vehicular traffic information may depict traffic jams on major roadways of a region. However, the location information received after three hours may cause the vehicular traffic information to be updated to depict free flowing traffic on the roadways in the region.

In another embodiment, at least one of the object behavior and trend model and the traffic flow model may be updated, based on update in the object behavioral and trending information and the vehicular traffic information.

At 412, at least one of the object behavioral and trending information and the vehicular traffic information generated is transmitted to at least one information database, such as the information database 208, explained in FIG. 2. The at least one information database may be communicably coupled to provide the object behavioral and trending information and the vehicular traffic information to external systems, such as Department of Transportation, and various businesses.

At 414, at least one of the object behavior and trend model and the traffic flow model is transmitted to the at least one information database. The object behavior and trend model and the traffic flow model may also be utilized by the externals systems.

In an embodiment, at least one of the object behavioral and trending information and the vehicular traffic information is transmitted to the at least one information database after the update. Further, at least one of the object behavior and trend model and the traffic flow model is transmitted to the at least one information database after the update.

At 416, the method 400 ends. It will be apparent to a person skilled in the art that the method 400 described above is capable of being utilized for other applications that are based on the location information of the plurality of objects.

A system, such as the system 200, and a method, such as the method 300 and the method 400, of the present invention are advantageous for improving applications that are based on the location information of a plurality of objects. Examples of the location information of an object include latitude, longitude, and the like. Examples of an object include a human, a vehicle, and the like. The location information may be easily obtained through location-aware devices, such as mobile phones, laptops, Personal Digital Assistants (PDAs), sensors, and the like. Further, the system does not require deployment of special purpose equipment for carrying out the present invention. Furthermore, the method and the system, as described above, are globally scalable and cost effective. The system is beneficial for providing accurate vehicular traffic information in a particular region. Further, object behavioral and trending information generated by the system is beneficial for various businesses in targeting the marketing and advertisement tools appropriately.

As described above, the embodiments of the present invention may be embodied in the form of a computer program product for improving applications that are based on location information of a plurality of objects. Embodiments of the present invention may also be embodied in the form of program module containing a set of instructions embodied in tangible media, such as floppy diskettes, CD-ROMs, hard drives, or any other computer-readable storage medium, wherein, when the program module is loaded into and executed by a computer, the computer becomes an apparatus for practicing the present invention. It will be apparent to a person skilled in the art that the present invention as described above, may be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the present invention. When implemented on a general-purpose microprocessor, the computer program code segments configure the microprocessor to create specific logic circuits.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, to thereby enable others skilled in the art to best utilize the present invention and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present invention.

What is claimed is:

1. A system for improving applications based on location information of a plurality of objects, the system comprising:
a receiver module configured to receive the location information of the plurality of objects from at least one location database in a communication network, the plurality of objects being associated with corresponding location-aware devices, each location-aware device of the location-aware devices comprising the location information of at least one object of the plurality of objects;
a processing module configured to generate at least one of object behavioral and trending information, and vehicular traffic information based on the location information of the plurality of objects; and
a transmitter module configured to transmit at least one of the object behavioral and trending information and the vehicular traffic information generated by the processing module to at least one information database through the communication network.

2. The system of claim 1, wherein the processing module is further configured to generate at least one of:
an object behavior and trend model based on the object behavioral and trending information; and
a traffic flow model based on the vehicular traffic information.

3. The system of claim 2, wherein the transmitter module is capable of transmitting at least one of the object behavior and trend model and the traffic flow model to the at least one information database through the communication network.

4. The system of claim 1, wherein each location-aware device is capable of estimating the location information of the at least one object, the at least one object associated with the location-aware device.

5. The system of claim 1, wherein the receiver module receives the location information of the plurality of objects at periodic intervals from the at least one location database.

6. The system of claim 5, wherein the processing module is further configured to update at least one of the object behavioral and trending information, and the vehicular traffic information based on the location information received at periodic intervals.

7. The system of claim 1, wherein the receiver module is further configured to receive object identification information corresponding to the location information of plurality of the objects, wherein the object identification information uniquely identifies at least one of an object of the plurality of objects and a location-aware device associated with the at least one object.

8. A method for improving applications based on location information of a plurality of objects, the method comprising:
receiving the location information of the plurality of objects from at least one location database in a communication network, the plurality of objects being associated with corresponding location-aware devices, each location-aware device of the location-aware devices comprising the location information of at least one object of the plurality of objects;
generating at least one of object behavioral and trending information, and vehicular traffic information based on the location information of the plurality of objects; and
transmitting at least one of the object behavioral and trending information and the vehicular traffic information generated to at least one information database through the communication network.

9. The method of claim 8, wherein the location information of an object of the plurality of objects comprises at least one of latitude of the object, longitude of the object, altitude of the object, velocity of the object, direction of the object and time.

10. The method of claim 8 further comprising generating at least one of:
an object behavior and trend model based on the object behavioral and trending information; and
a traffic flow model based on the vehicular traffic information.

11. The method of claim 10 further comprising transmitting at least one of the object behavior and trend model and the traffic flow model to the at least one information database through the communication network.

12. The method of claim 8, wherein the location information is received at periodic intervals from the at least one location database.

13. The method of claim 12 further comprising updating at least one of the object behavioral and trending information, and the vehicular traffic information based on the location information received at periodic intervals.

14. The method of claim 8 further comprising receiving object identification information corresponding to the location information of the plurality of objects, wherein the object identification information uniquely identifies at least one of an object of the plurality of objects and a location-aware device associated with the at least one object.

15. A computer program product embodied on a computer readable medium for improving applications based on location information of a plurality of objects, the computer program product comprising a program module, the program module comprising:
a set of instructions for receiving the location information of the plurality of objects from at least one location database in a communication network, the plurality of objects being associated with corresponding location-aware devices, each location-aware device of the location-aware devices comprising the location information of at least one object of the plurality of objects;
a set of instructions for generating at least one of object behavioral and trending information, and vehicular traffic information based on the location information of the plurality of objects; and
a set of instructions for transmitting at least one of the object behavioral and trending information and the vehicular traffic information generated to at least one information database through the communication network.

16. The computer program product according to claim 15, wherein the program module further comprises a set of instructions for generating at least one of:
an object behavior and trend model based on the object behavioral and trending information; and
a traffic flow model based on the vehicular traffic information.

17. The computer program product according to claim 16, wherein the program module further comprises a set of instructions for transmitting at least one of the object behavior and trend model, and the traffic flow model to the at least one information database through the communication network.

18. The computer program product according to claim 15, wherein the location information is received at periodic intervals from the at least one location database.

19. The computer program product according to claim 18, wherein the program module further comprises a set of instructions for updating at least one of the object behavioral and trending information, and the vehicular traffic information based on the location information received at periodic intervals.

20. The computer program product according to claim 15, wherein the program module further comprises a set of instructions for receiving object identification information corresponding to the location information of the plurality of objects, wherein the object identification information uniquely identifies at least one of an object of the plurality of objects and a location-aware device associated with the at least one object.
